(19) United States
(12) Patent Application Publication
(10) Pub. No.: US 2026/0200277 A1
(43) Pub. Date: Jul. 16, 2026

(54) INDUSTRIAL TRUCK FOR TRANSPORTING CONTAINERS ON A SUPPORTING FRAME (STABILISATION SYSTEM)

(71) Applicants: BASF SE, Ludwigshafen am Rhein (DE); VDL STEELWELD B.V., BJ Breda (NL)

(72) Inventors: Thorsten BIEKER, Ludwigshafen am Rhein (DE); Roland SENNINGER, Ludwigshafen am Rhein (DE); Karel Andreas SMITS, BJ Breda (NL)

(21) Appl. No.: 19/136,636

(22) PCT Filed: Dec. 20, 2023
(86) PCT No.: PCT/EP2023/086985

§ 371 Date: Jun. 6, 2025

(30) Foreign Application Priority Data
Dec. 21, 2022 (EP) 22215500.4

(51) Int. Cl. B60G 17/016; B60G 13/00; B60G 17/019; B60G 17/08; B60G 21/073; B62D 33/02

(52) U.S. Cl. CPC B60G 17/016; B60G 13/001; B60G 17/019; B60G 17/08; B60G 21/073; B62D 33/02; B60G 2202/24; B60G 2300/02; B60G 2400/252; B60G 2400/50; B60G 2400/61; B60G 2500/10; B60G 2500/30

(57) ABSTRACT

An industrial truck (100) for transporting at least one container (102) is disclosed. The industrial truck (100) includes a vehicle frame (104) including a loading platform (106) formed by an upper surface (108) of the vehicle frame (104), height-adjustable wheel suspensions (110), a power source (148) configured for supplying power to the wheels (112), a control unit (154) configured for controlling an operation of the industrial truck (100), and a stabilizing mechanism (178) connecting at least some wheel suspensions (110) of laterally adjacent quadrants (114, 116, 118, 120) on opposite sides of a longitudinal axis (180) of the industrial truck (100). Further, a system (160) and a method of stabilizing an industrial truck (100) are disclosed.

### TECHNICAL FIELD

The present invention relates to an industrial truck for transporting a container on a support frame. The present invention further relates to a system comprising an industrial truck and at least one self-supporting support frame. The present invention further relates to a method of stabilizing the industrial truck.

### BACKGROUND ART

Industrial trucks and support frames for transporting containers are well known in the art. The document DE 2 137 729 A discloses a vehicle with a swap body which can be lifted off the vehicle frame. The swap body comprises legs via which it can be placed on the ground. The legs are pivotably attached to the swap body like a parallelogram or trapezoid such that a horizontal movement of the swap body induces a lifting or lowering movement of the swap body. The vehicle comprises a locking device by means of which the swap body placed on the vehicle can be connected to the vehicle frame in such a way that it cannot be lifted off or moved while locked. The swap body has engagement elements which engage in holders of the vehicle frame and which have slots. In order to lock a plurality of locking elements together, the swap body is moved horizontally after being placed down on the vehicle and the engagement elements of the locking elements are inserted into the horizontal sections of the slots.

Document DE 20 2010 006 522 U1 discloses a changing device for connecting and disconnecting a swap body and a transport vehicle. In a parking position, the swap body is located on support legs with a distance of the swap body to the ground. To load the swap body onto the vehicle the swap body is lifted out of the support legs by raising the changing device. This is done by raising the level of the vehicle's air suspension. The swap body is then moved in the longitudinal direction onto the vehicle by a shifting device. The locking elements interlock and secure the swap body against vertical movement upwards and in the direction of travel.

To interlock a container on a vehicle or on a support frame, twist locks are most common in the art. Twist locks are locking devices that connect swap bodies or ISO containers to each other or to a carrier vehicle. Twist locks are inserted into the standardized corner castings of the containers. Alternatively, the containers are placed on the twist locks permanently attached to the vehicle. A part of the twist lock is then twisted by 90° to create a positive connection.

Document EP 1 937 511 B1 discloses an alternative locking device for locking an ISO-standardized corner casting of a freight container to a vehicle. The locking device comprises locking means which are adjustable between an opened position in which the locking means can freely pass an opening of the corner casting, and a closed position in which the locking means hook behind the opening of a wall surrounding the opening of the corner casting. The locking device further comprises operating means which, upon placement of a container on the locking device, are adjustable through cooperation with a wall of the corner casting from an unloaded initial position to an end position loaded by the weight of the container, and an adjusting mechanism with a scissor mechanism which couples the locking means and the operating means in a manner such that upon placement of a corner casting of a container on the locking device, the weight load of the container energizes the locking means towards the closed position.

The amount of freight transported via containers has continuously increased over time and it is still increasing, both in number of containers as well as in their frequency of circulation. Although considerable improvements have been achieved by such industrial trucks and means for transportation, conventional means of transportation struggle with this increase and require new techniques for transportation with a higher degree of automation. Particularly, transportation costs are an important part of logistics costs. Truck transport is faster and more flexible compared to rail transport. Rail has the advantage of higher payloads.

It is therefore desirable to provide a cost efficient, flexible transport solution that is able to transport onsite (terminals, industrial areas) and offsite (public roads) same payloads like a rail flat wagon (up to 74 tons) but at the same time are able to drive very flexible on standard and shared road infrastructure like a normal truck (payload 25 tons) resulting in a more efficient onsite and offsite transport due to lower transportation costs. Particularly, it is an object of the present invention to provide a self-propelled automatic means of transport that can carry very high tonnages, strengthens rail traffic in intermodal transport in the pre- and on-carriage, is electro-mobile or otherwise CO₂ neutral, can drive in normal traffic and can be used very well logistically.

### SUMMARY

This problem is addressed by an industrial truck for transporting a container on a support frame, a system comprising an industrial truck and at least one self-supporting support frame, and a method of stabilizing an industrial truck with the features of the independent claims. Advantageous embodiments which might be realized in an isolated fashion or in any arbitrary combinations are listed in the dependent claims as well as throughout the specification.

In a first aspect of the present invention, an industrial truck for transporting at least one container is provided, wherein the industrial truck comprises:
a vehicle frame comprising a loading platform formed by an upper surface of the vehicle frame, height-adjustable wheel suspensions, wherein the wheel suspensions each comprise at least two adjacent wheels, wherein the wheel suspensions are arranged as four independent quadrants, wherein the quadrants are arranged as pairs at a front portion and a rear portion of the vehicle frame with respect to a longitudinal direction of the industrial truck,
a power source configured for supplying power to the wheels,
a control unit configured for controlling an operation of the industrial truck, and
a stabilizing mechanism connecting at least some wheel suspensions of laterally adjacent quadrants on opposite sides of a longitudinal axis of the industrial truck, wherein the stabilizing mechanism is configured for at least partially hydraulically coupling at least one wheel suspension of at least one of the quadrants with at least one corresponding wheel suspension of a quadrant on an opposite side of the longitudinal axis in an inverse fashion.

The vehicle frame allows to carry a support frame on which a container may be present. The load can be picked up and set down independently. For this purpose, the vehicle carries such a support frame. When setting down, the vehicle lowers the height until the frame is on the ground and then passes under the frame or drives under the frame when picking up and raises it. The vehicle can independently unlock and lock the frame and container so that the container and frame are secured on the vehicle during travel. The industrial truck can transport very high weights and several transport containers at the same time with a payload of even more than 75t. So that the vehicle can go up and down in height, it is equipped with a hydraulic wheel suspension system. The wheel suspension system is also designed to distribute the load evenly on the road. For this purpose, the suspension system is divided into four quadrants, i.e. front left, front right, rear left, rear right. All bearing parts of a quadrant in the suspension system are coupled together so that the forces in each quadrant are always evenly distributed and the ground pressure on each wheel is virtually the same. When transporting only a 20-foot load-bearing frame, there is higher ground pressure on the loaded side than on the unloaded side, but the limits of the SLW60 are not exceeded, and the ground pressure is evenly distributed on both the loaded and unloaded sides. Lateral stabilization of the vehicle is achieved by precisely coupling some axle sections on the left and right of the front and/or rear by means of the stabilizing mechanism. Further, the stabilizing mechanism allows a transport of liquids without sloshing independent on the liquid level within the container.

The stabilizing mechanism may be configured such that, when a load acts on the at least one wheel suspension of the quadrant, the hydraulic coupling softens a damping of the corresponding at least one wheel suspension of the quadrant on an opposite side of the longitudinal axis. Thereby, the lateral stabilization of the vehicle is improved by precisely coupling some axle sections on the left and right of the front and/or rear by means of the stabilizing mechanism.

The wheel suspensions may each comprise at least one hydraulic cylinder, wherein the hydraulic cylinders may be filled with a hydraulic fluid, wherein the hydraulic cylinders are filled with a hydraulic fluid, wherein the stabilizing mechanism comprises a fluid communication of the hydraulic fluid of a predetermined number of the hydraulic cylinders of the wheel suspensions of a quadrant with a predetermined number of the hydraulic cylinders of a laterally adjacent quadrant on the opposite side of the longitudinal axis. Thus, not all hydraulic cylinders of laterally quadrants need to be connected to one another but only some of them. Thereby, the lateral stabilization of the vehicle is improved by precisely coupling some axle sections on the left and right of the front and/or rear by means of the stabilizing mechanism.

Each of the hydraulic cylinders may comprise a piston, wherein the fluid communication may comprise a connection of a hydraulic volume defined by a top side of the piston of the at least one hydraulic cylinder of the at least one wheel suspension of the quadrant to a hydraulic volume defined by a lower side of the piston of the at least one hydraulic cylinder of the at least one wheel suspension of the quadrant on the opposite side of the longitudinal axis, and vice versa. Thus, if a load deviates from a center point, such as when the industrial truck moves along a curve, the load pressure acting on the one side of the industrial truck increases and this pressure acts as a negative pressure on the other side of the industrial truck. Thereby, a torsional moment or torque in the opposite direction is caused which counter-acts the load so as to cause a balancing effect.

The predetermined number may be less than a total number of hydraulic cylinders number of the hydraulic cylinders of the wheel suspensions of laterally adjacent quadrants. Thereby, the balancing and load distributing effects are improved

The wheel suspensions may be height-adjustable by means of the hydraulic cylinders. Thereby, the height may be varied by means of hydraulically operated constructional members which are well established in the field of the present disclosure.

The amount of hydraulic fluid may be separately adjustable for each quadrant. Thereby, an adaption of the stabilizing effect to varying loads may be separately done for each hydraulic cylinder.

The industrial truck may further comprise a hydraulic system comprising at least one hydraulic fluid reservoir storing the hydraulic fluid, a hydraulic fluid pump and a hydraulic fluid line, wherein the hydraulic fluid reservoir may be in fluid communication with the hydraulic cylinders of each quadrant by means of the hydraulic fluid line, wherein the hydraulic pump may be configured for independently supplying hydraulic fluid to and/or discharging hydraulic fluid from the hydraulic cylinders of each quadrant so as to adjust the amount of hydraulic fluid for each quadrant.

The hydraulic system may be configured to close the hydraulic fluid line for laterally quadrants at least during a drive of the industrial truck. Thereby, the pressure within the closed hydraulic fluid line is the same during a drive such that the balancing effect is always the same.

The hydraulic cylinders of each of the quadrants may be in fluid communication with one another. Thereby, the load may be evenly distributed.

The height of the industrial truck may be adjustable by means of adjusting the amount of hydraulic fluid. Thus, by varying the amount of hydraulic fluid within the hydraulic cylinders, the height of the industrial truck may be varied.

The hydraulic fluid may comprise a hydraulic liquid. Such a hydraulic liquid is incompressible such that the pressure conditions within the hydraulic system are constant.

The hydraulic fluid may further comprises a gas, particularly nitrogen. Such a gas causes a dampening effect such as when moving across uneven ground.

The industrial truck may further comprise a height sensor configured for determining a height of the industrial truck. Thus, the height of the industrial truck may detected which allows to precisely control the adjustment of the height.

Each of the hydraulic cylinders may comprise a cylinder casing, a piston, a piston rod and a hinge, wherein the piston and the piston rod may be moveably arranged with respect to the cylinder casing, wherein the cylinder casing and the piston rod may be connected to one another by means of the hinge. Thus, the hydraulic cylinder may be moved between an expanded position and a retracted position.

The height sensor may be configured for determining the height of the industrial truck by detecting a position of the hinge. Thus, depending on the position of the hinge portion relative to one another, the height of the industrial truck may be determined.

The industrial truck may further comprise at least one load sensor associated with each quadrant, wherein the load sensor may be configured for detecting a load acting on the respective quadrant. Thus, the load acting on the industrial truck may be precisely determined. Further, the weight of the container and the contents stored therein may be determined. Thereby, the fill level of the container may be determined which allows to avoid and potential flush, sloshing and/or swinging of the contents of the container.

The number of wheels may be determined such that a ground pressure of the industrial truck in a loaded state is less than or equal to a predetermined threshold. Thus, the load may be evenly distributed to the ground without exceeding a threshold which allows the industrial truck to drive at public road surfaces.

The threshold may be 833 kN/m². A lower threshold may be preferred depending on the local requirements.

The industrial truck may comprise at least 8 wheels, preferably at least 10 wheels and more preferably at least 16 wheels such as at least 32 wheels. Thereby the ground pressure is reduced.

Each wheel suspension may comprise two wheels. Thus, it is ensured that at least one wheel per wheel suspension contacts the ground.

The industrial truck may be moveable in two opposite directions. Thus, the industrial truck may move in a flexible manner.

The industrial truck may further comprise lights arranged at the front portion and the rear portion of the vehicle frame. Thus, the visibility of the industrial truck is improved.

The control unit may be configured to switch the lights at the front portion and the rear portion of the vehicle frame to a state of forward or rearward moving. Thus, the industrial truck may be identically designed at the front and rear portions and flexibly change the light status depending on the movement direction.

The height-adjustable wheel suspensions may be configured for lowering and raising the industrial truck relative to a ground surface, particularly a road surface. Thereby, a support frame may be picked up.

The industrial truck may be configured for transporting the at least one container on a support frame. Thus, the industrial truck may transport standardized containers.

The vehicle frame may further comprise engagement elements for fixing the support frame onto the loading platform. Thus, the support frame may be reliably fixed to the vehicle frame which avoids any movement of the support frame relative to the vehicle frame when fixed.

The power source and the control unit may be arranged below the loading platform. Thus, the power source and the control unit may be arranged in a compact manner without being a potential obstacle for the picking up and setting up of the support frame.

In a further aspect of the present invention, there is provided a system comprising an industrial truck according to any one of the embodiments disclosed before or hereinafter and at least one self-supporting support frame for receiving at least one container, wherein the support frame comprises four legs, the lateral distance of which is greater than a width of the industrial truck, and the height of which is dimensioned such that the industrial truck can be moved under the support frame in a lowered state, and the legs are at a distance from a ground surface in a raised state of the industrial truck. Thus, the industrial truck and the support frame may be a kit and operate precisely together.

The vehicle frame may further comprise engagement elements for fixing the support frame onto the loading platform, wherein the support frame may further comprise openings engageable by the movable engagement elements in order to fix the support frame on the industrial truck, wherein the vehicle frame may further comprise a locking device actuatable by the engagement of the engagement elements and the openings in order to fix a container located on the support frame in the locked state. Thus, the container may be automatically fixed to the support frame when the support frame is fixed to the vehicle frame.

The legs may be mounted stationary to the support frame. Thus, without any additional operation step the support frame may be disposed at any desired surface.

The industrial truck may be controlled by a control station. The control station may be located at the industrial truck. Thus, the control of the operation of the industrial truck may be carried out directly the industrial truck so as to accelerate any changes of the operation. Alternatively, the control station may be external to or remote from the industrial truck. Thus, the control of the operation of the industrial truck may be remotely carried out which allows to fully automatize the operation of the industrial truck.

In a further aspect of the present invention, there is provided a method of stabilizing the industrial truck according to any one of the embodiments disclosed before or hereinafter. The method comprises the following steps:
a) at least partially hydraulically coupling at least one wheel suspension of at least one of the quadrants with at least one corresponding wheel suspension of a quadrant on an opposite side of the longitudinal axis in an inverse fashion,
b) adjusting a predetermined height of the wheel suspensions, and
c) closing the hydraulic coupling of the wheel suspensions of the quadrants on opposite sides of the longitudinal axis.

Thereby, the container and/or support frame transported is always balanced and the load thereof evenly distributed without the risk of potential shifting during a drive of the industrial truck.

The predetermined height of the wheel suspensions may be adjusted by supplying a predetermined amount of a hydraulic fluid to the wheel suspensions. Thus, industrial truck may be raised or lowered by supplying hydraulic fluid to the hydraulic cylinders of the wheel suspensions or by discharging hydraulic fluid from the hydraulic cylinders of the wheel suspensions.

The method may be computer-implemented. Thus, the industrial truck may carry out the stabilizing process in an automated manner.

The term “industrial truck” as used herein is a broad term and is to be given its ordinary and customary meaning to a person of ordinary skill in the art and is not to be limited to a special or customized meaning. The term specifically may refer, without limitation, to any vehicle or machine that is designed to transport loads. The industrial truck may be steered by a driver or may be a driverless industrial truck. Industrial trucks are known in the art and are subject to several industrial standards, for example the standard ISO 3691-4:2060(en) by the International Organization for Standardization (ISO) as in force at the filing date of the present application. In a preferred embodiment, the industrial truck is an automated guided vehicle that is automatically controlled and guided in its standard operation mode. Preferably, the automated guided vehicle can be monitored and controlled from a control center.

The term “vehicle frame” as used herein is a broad term and is to be given its ordinary and customary meaning to a person of ordinary skill in the art and is not to be limited to a special or customized meaning. The term specifically may refer, without limitation, to any frame of an industrial truck and that is capable to be loaded with containers, preferably with containers with corner castings. Particularly, the vehicle frame may be configured to pick up a support frame configured for being loaded with a container.

The term “support frame” as used herein is a broad term and is to be given its ordinary and customary meaning to a person of ordinary skill in the art and is not to be limited to a special or customized meaning. The term specifically may refer, without limitation, to any self-supporting frame that can be picked up by an industrial truck and that is capable to be loaded with containers, preferably with containers with corner castings.

The term “container” as used herein is a broad term and is to be given its ordinary and customary meaning to a person of ordinary skill in the art and is not to be limited to a special or customized meaning. The term specifically may refer, without limitation, to any container that can be loaded upon a vehicle or a support frame to be transported by a vehicle. In a preferred embodiment, container refers to an intermodal container or shipping container with corner castings. More preferably the container is a 20-feet or 40-feet standard intermodal container.

The term “loading platform” as used herein is a broad term and is to be given its ordinary and customary meaning to a person of ordinary skill in the art and is not to be limited to a special or customized meaning. The term specifically may refer, without limitation, to a portion of the vehicle frame that is configured to be loaded with a support frame for carrying a container and to engage the support frame.

The term “quadrant” as used herein is a broad term and is to be given its ordinary and customary meaning to a person of ordinary skill in the art and is not to be limited to a special or customized meaning. The term specifically may refer, without limitation, to a region that is form by axes of a two-dimensional system dividing the plane into four regions.

The term “wheel suspension” as used herein is a broad term and is to be given its ordinary and customary meaning to a person of ordinary skill in the art and is not to be limited to a special or customized meaning. The term specifically may refer, without limitation, to a system of wheels or tires, tire air, springs, shock absorbers, linkages and the like that connects a vehicle to its wheels and allows relative motion between the two. Wheel suspensions must support both road holding/handling and ride quality, which are at odds with each other. The tuning of suspensions involves finding the right compromise. It is important for the suspension to keep the road wheel in contact with the road surface as much as possible, because all the road or ground forces acting on the vehicle do so through the contact patches of the tires. The suspension also protects the vehicle itself and any cargo or luggage from damage and wear. The design of front and rear suspension of a car may be different.

The term “wheel suspension” as used herein is a broad term and is to be given its ordinary and customary meaning to a person of ordinary skill in the art and is not to be limited to a special or customized meaning. The term specifically may refer, without limitation, to any source that is configured for supplying power to the wheels. The supplied power is particularly a drive power. The power source may comprise a drive or motor such as a combustion engine or more preferably an electric motor.

The term “control unit” as used herein is a broad term and is to be given its ordinary and customary meaning to a person of ordinary skill in the art and is not to be limited to a special or customized meaning. The term specifically may refer, without limitation, to a systems such as an embedded system in automotive electronics that controls one or more of the electrical systems or subsystems in a car or other motor vehicle, particularly, the industrial truck. The term may particularly refer to an electronic control unit (ECU). Modern vehicles have many ECUs, and these can include some or all of the following: engine control module (ECM), powertrain control module (PCM), transmission control module (TCM), brake control module (BCM or EBCM), central control module (CCM), central timing module (CTM), general electronic module (GEM), body control module (BCM), and suspension control module (SCM). These ECUs together are sometimes referred to collectively as the car's computer though technically they are all separate computers, not a single one. Sometimes an assembly incorporates several individual control modules (a PCM often controls both the engine and the transmission).

The term “stabilizing mechanism” as used herein is a broad term and is to be given its ordinary and customary meaning to a person of ordinary skill in the art and is not to be limited to a special or customized meaning. The term specifically may refer, without limitation, to a mechanism or system that is configured for maintaining the orientation within space of the industrial truck. Particularly, the stabilizing mechanism may refer to a mechanism or system that is configured for balancing, equalizing and/or distributing load forces acting on respective quadrants to adjacent quadrants.

The term “hydraulic cylinder” as used herein is a broad term and is to be given its ordinary and customary meaning to a person of ordinary skill in the art and is not to be limited to a special or customized meaning. The term specifically may refer, without limitation, to a mechanical actuator that is used to give a unidirectional force through a unidirectional stroke. It has many applications, notably in construction equipment (engineering vehicles), manufacturing machinery, elevators, and civil engineering. Hydraulic cylinders get their power from pressurized hydraulic fluid, which is substantially incompressible. Typically oil is used as hydraulic fluid. The hydraulic cylinder consists of a cylinder barrel, in which a piston connected to a piston rod moves back and forth. The barrel is closed on one end by the cylinder bottom (also called the cap) and the other end by the cylinder head (also called the gland) where the piston rod comes out of the cylinder. The piston has sliding rings and seals. The piston divides the inside of the cylinder into two chambers, the bottom chamber (cap end) and the piston rod side chamber (rod end/headend).

The term “hydraulic fluid” as used herein is a broad term and is to be given its ordinary and customary meaning to a person of ordinary skill in the art and is not to be limited to a special or customized meaning. The term specifically may refer, without limitation, to a medium by which power is transferred in hydraulic machinery. Common hydraulic fluids are based on mineral oil or water. Examples of equipment that might use hydraulic fluids are excavators and backhoes, hydraulic brakes, power steering systems, automatic transmissions, garbage trucks, aircraft flight control systems, lifts, and industrial machinery. Hydraulic systems like the ones mentioned above will work most efficiently if the hydraulic fluid used has zero compressibility.

The term “hydraulic fluid reservoir” as used herein is a broad term and is to be given its ordinary and customary meaning to a person of ordinary skill in the art and is not to be limited to a special or customized meaning. The term specifically may refer, without limitation, to any device such as a tank configured for at least temporally storing and/or buffering hydraulic fluid. The hydraulic fluid reservoir may be a tank or the like.

The term “hydraulic line” as used herein is a broad term and is to be given its ordinary and customary meaning to a person of ordinary skill in the art and is not to be limited to a special or customized meaning. The term specifically may refer, without limitation, to any fluid connection configured for allowing hydraulic fluid to pass therethrough so as to convey the fluid from one location to another. The hydraulic line may be a tube, a channel and/or a pipe.

The term “height-adjustable” as used herein is a broad term and is to be given its ordinary and customary meaning to a person of ordinary skill in the art and is not to be limited to a special or customized meaning. The term specifically may refer, without limitation, to a characteristics of a constructional member to vary its height. The height is the distance from a leading end or the uppermost portion of a constructional member with respect to a predetermined plane, particularly a floor, road or soil.

Further disclosed and proposed herein is a computer program including computer-executable instructions for performing the method according to the present invention in one or more of the embodiments enclosed herein when the program is executed on a computer or computer network. Specifically, the computer program may be stored on a computer-readable data carrier and/or on a computer-readable storage medium.

As used herein, the terms “computer-readable data carrier” and “computer-readable storage medium” specifically may refer to non-transitory data storage means, such as a hardware storage medium having stored thereon computer-executable instructions. The computer-readable data carrier or storage medium specifically may be or may comprise a storage medium such as a random-access memory (RAM) and/or a read-only memory (ROM).

Thus, specifically, one, more than one or even all of method steps a) to c) as indicated above may be performed by using a computer or a computer network, preferably by using a computer program.

Further disclosed and proposed herein is a computer program product having program code means, in order to perform the method according to the present invention in one or more of the embodiments enclosed herein when the program is executed on a computer or computer network. Specifically, the program code means may be stored on a computer-readable data carrier and/or on a computer-readable storage medium.

Further disclosed and proposed herein is a data carrier having a data structure stored thereon, which, after loading into a computer or computer network, such as into a working memory or main memory of the computer or computer network, may execute the method according to one or more of the embodiments disclosed herein.

Further disclosed and proposed herein is a computer program product with program code means stored on a machine-readable carrier, in order to perform the method according to one or more of the embodiments disclosed herein, when the program is executed on a computer or computer network. As used herein, a computer program product refers to the program as a tradable product. The product may generally exist in an arbitrary format, such as in a paper format, or on a computer-readable data carrier and/or on a computer-readable storage medium. Specifically, the computer program product may be distributed over a data network.

Finally, disclosed and proposed herein is a modulated data signal which contains instructions readable by a computer system or computer network, for performing the method according to one or more of the embodiments disclosed herein.

Referring to the computer-implemented aspects of the invention, one or more of the method steps or even all of the method steps of the method according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual measurements.

Specifically, further disclosed herein are:
a) a computer or computer network comprising at least one processor, wherein the processor is adapted to perform the method according to one of the embodiments described in this description,
b) a computer loadable data structure that is adapted to perform the method according to one of the embodiments described in this description while the data structure is being executed on a computer,
c) a computer program, wherein the computer program is adapted to perform the method according to one of the embodiments described in this description while the program is being executed on a computer,
d) a computer program comprising program means for performing the method according to one of the embodiments described in this description while the computer program is being executed on a computer or on a computer network,
e) a computer program comprising program means according to the preceding embodiment, wherein the program means are stored on a storage medium readable to a computer,
f) a storage medium, wherein a data structure is stored on the storage medium and wherein the data structure is adapted to perform the method according to one of the embodiments described in this description after having been loaded into a main and/or working storage of a computer or of a computer network, and
g) a computer program product having program code means, wherein the program code means can be stored or are stored on a storage medium, for performing the method according to one of the embodiments described in this description, if the program code means are executed on a computer or on a computer network.

As used herein, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically are used only once when introducing the respective feature or element. In most cases, when referring to the respective feature or element, the expressions “at least one” or “one or more” are not repeated, nonwithstanding the fact that the respective feature or element may be present once or more than once.

Further, as used herein, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

Summarizing and without excluding further possible embodiments, the following embodiments may be envisaged:
Embodiment 1: An industrial truck for transporting at least one container, the industrial truck comprising
a vehicle frame comprising a loading platform formed by an upper surface of the vehicle frame, height-adjustable wheel suspensions, wherein the wheel suspensions each comprise at least two adjacent wheels, wherein the wheel suspensions are arranged as four independent quadrants, wherein the quadrants are arranged as pairs at a front portion and a rear portion of the vehicle frame with respect to a longitudinal direction of the industrial truck,
a power source configured for supplying power to the wheels,
a control unit configured for controlling an operation of the industrial truck, and
a stabilizing mechanism connecting at least some wheel suspensions of laterally adjacent quadrants on opposite sides of a longitudinal axis of the industrial truck, wherein the stabilizing mechanism is configured for at least partially hydraulically coupling at least one wheel suspension of at least one of the quadrants with at least one corresponding wheel suspension of a quadrant on an opposite side of the longitudinal axis in an inverse fashion.
Embodiment 2: The industrial truck according to the preceding embodiment, wherein the stabilizing mechanism is configured such that, when a load acts on the at least one wheel suspension of the quadrant, the hydraulic coupling softens a damping of the corresponding at least one wheel suspension of the quadrant on an opposite side of the longitudinal axis.
Embodiment 3: The industrial truck according to any one of the preceding embodiments, wherein the wheel suspensions each comprise at least one hydraulic cylinder, wherein the hydraulic cylinders are filled with a hydraulic fluid, wherein the hydraulic cylinders are filled with a hydraulic fluid, wherein the stabilizing mechanism comprises a fluid communication of the hydraulic fluid of a predetermined number of the hydraulic cylinders of the wheel suspensions of a quadrant with a predetermined number of the hydraulic cylinders of a laterally adjacent quadrant on the opposite side of the longitudinal axis.
Embodiment 4: The industrial truck according to the preceding embodiment, wherein each of the hydraulic cylinders comprises a piston, wherein the fluid communication comprises a connection of a hydraulic volume defined by a top side of the piston of the at least one hydraulic cylinder of the at least one wheel suspension of the quadrant to a hydraulic volume defined by a lower side of the piston of the at least one hydraulic cylinder of the at least one wheel suspension of the quadrant on the opposite side of the longitudinal axis, and vice versa.
Embodiment 5: The industrial truck according to any one of the two preceding embodiments, wherein the predetermined number is less than a total number of hydraulic cylinders number of the hydraulic cylinders of the wheel suspensions of laterally adjacent quadrants.
Embodiment 6: The industrial truck according to any one of the three preceding embodiments, wherein the wheel suspensions are height-adjustable by means of the hydraulic cylinders.
Embodiment 7: The industrial truck according to any one of the four preceding embodiments, wherein the amount of hydraulic fluid is separately adjustable for each quadrant.
Embodiment 8: The industrial truck according to the preceding embodiment, further comprising a hydraulic system comprising at least one hydraulic fluid reservoir storing the hydraulic fluid, a hydraulic fluid pump and a hydraulic fluid line, wherein the hydraulic fluid reservoir is in fluid communication with the hydraulic cylinders of each quadrant by means of the hydraulic fluid line, wherein the hydraulic pump is configured for independently supplying hydraulic fluid to and/or discharging hydraulic fluid from the hydraulic cylinders of each quadrant so as to adjust the amount of hydraulic fluid for each quadrant.
Embodiment 9: The industrial truck according to the preceding embodiment, wherein the hydraulic system is configured to close the hydraulic fluid line for laterally quadrants at least during a drive of the industrial truck.
Embodiment 10: The industrial truck according to any one of the six preceding embodiments, wherein the hydraulic cylinders of each of the quadrants are in fluid communication with one another.
Embodiment 11: The industrial truck according to any one of the seven preceding embodiments, wherein the height of the industrial truck is adjustable by means of adjusting the amount of hydraulic fluid.
Embodiment 12: The industrial truck according to any one of the eight preceding embodiments, wherein the hydraulic fluid comprises a hydraulic liquid.
Embodiment 13: The industrial truck according to the preceding embodiment, wherein the hydraulic fluid further comprises a gas, particularly nitrogen.
Embodiment 14: The industrial truck according to any one of the ten preceding embodiments, further comprising a height sensor configured for determining a height of the industrial truck.
Embodiment 15: The industrial truck according to the preceding embodiment, wherein each of the hydraulic cylinders comprise a cylinder casing, a piston, a piston rod and a hinge, wherein the piston and the piston rod are moveably arranged with respect to the cylinder casing, wherein the cylinder casing and the piston rod are connected to one another by means of the hinge.
Embodiment 16: The industrial truck according to the preceding embodiment, wherein the height sensor is configured for determining the height of the industrial truck by detecting a position of the hinge.
Embodiment 17: The industrial truck according to any one of the preceding embodiments, further comprising at least one load sensor associated with each quadrant, wherein the load sensor is configured for detecting a load acting on the respective quadrant.
Embodiment 18: The industrial truck according to any one of the preceding embodiments, wherein the number of wheels is determined such that a ground pressure of the industrial truck in a loaded state is less than or equal to a predetermined threshold.
Embodiment 19: The industrial truck according to the preceding embodiment, wherein the threshold is 833 kN/m².
Embodiment 20: The industrial truck according to any one of the preceding embodiments, wherein the industrial truck is moveable in two opposite directions.
Embodiment 21: The industrial truck according to any one of the preceding embodiments, further comprising lights arranged at the front portion and the rear portion of the vehicle frame.
Embodiment 22: The industrial truck according to the preceding embodiment, wherein the control unit is configured to switch the lights at the front portion and the rear portion of the vehicle frame to a state of forward or rearward moving.
Embodiment 23: The industrial truck according to any one of the preceding embodiments, wherein the height-adjustable wheel suspensions are configured for lowering and raising the industrial truck relative to a ground surface, particularly a road surface.
Embodiment 24: The industrial truck according to any one of the preceding embodiments, wherein the industrial truck is configured for transporting the at least one container on a support frame.
Embodiment 25: The industrial truck according to the preceding embodiment, wherein the vehicle frame further comprises engagement elements for fixing the support frame onto the loading platform.
Embodiment 26: The industrial truck according to any one of the preceding embodiments, wherein the power source and the control unit are arranged below the loading platform.
Embodiment 27: A system comprising an industrial truck according to any one of the preceding embodiments and at least one self-supporting support frame for receiving at least one container, wherein the support frame comprises four legs, the lateral distance of which is greater than a width of the industrial truck, and the height of which is dimensioned such that the industrial truck can be moved under the support frame in a lowered state, and the legs are at a distance from a ground surface in a raised state of the industrial truck
Embodiment 28: The system according to the preceding embodiment, wherein the vehicle frame further comprises engagement elements for fixing the support frame onto the loading platform, wherein the support frame further comprises openings engageable by the movable engagement elements in order to fix the support frame on the industrial truck, wherein the vehicle frame further comprises a locking device actuatable by the engagement of the engagement elements and the openings in order to fix a container located on the support frame in the locked state.
Embodiment 29: The system according to any one of the preceding embodiments referring to a system, wherein the legs are mounted stationary to the support frame.
Embodiment 30: A method of stabilizing the industrial truck according to any one of the embodiments referring to an industrial truck, the method comprising the following steps:
a) at least partially hydraulically coupling at least one wheel suspension of at least one of the quadrants with at least one corresponding wheel suspension of a quadrant on an opposite side of the longitudinal axis in an inverse fashion,
b) adjusting a predetermined height of the wheel suspensions, and
c) closing the hydraulic coupling of the wheel suspensions of the quadrants on opposite sides of the longitudinal axis.
Embodiment 31: The method according to the preceding embodiment, wherein the predetermined height of the wheel suspensions is adjusted by supplying a predetermined amount of a hydraulic fluid to the wheel suspensions.
Embodiment 32: The method according to any one of the preceding embodiments referring to a method, wherein the method is computer-implemented.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the Figures:

FIG. 1 shows a perspective view of an industrial truck; and

FIG. 2 shows a plan view of the industrial truck;

FIG. 3 shows a lateral view of the industrial truck in a raised position;

FIG. 4 shows a lateral view of the industrial truck in an intermediate position;

FIG. 5 shows a lateral view of the industrial truck in a lowered position;

FIG. 6 shows a front view of the industrial truck;

FIG. 7 shows a front view of the industrial truck in with wheels in a turned position;

FIG. 8 shows a front view of the industrial truck in with wheels in a pivoted position;

FIG. 9 shows a front view of the industrial truck in with wheels in another pivoted position;

FIG. 10 shows a perspective view of a driven bogie;

FIG. 11 shows a lateral view of the driven bogie in an intermediate position;

FIG. 12 shows a lateral view of the driven bogie in a lowered position;

FIG. 13 shows a lateral view of the driven bogie in a raised position;

FIG. 14 shows a perspective view of an undriven bogie;

FIG. 15 shows a lateral view of the undriven bogie in an intermediate position;

FIG. 16 shows a lateral view of the undriven bogie in a lowered position;

FIG. 17 shows a lateral view of the undriven bogie in a raised position;

FIG. 18 shows a schematical cross-sectional view of the industrial truck;

FIG. 19 shows a schematical plan view of a hydraulic system of industrial truck;

FIG. 20 shows a schematical illustration of a front portion of the hydraulic system of industrial truck;

FIG. 21 shows a schematical illustration of a rear portion of the hydraulic system of industrial truck; and

FIG. 22 shows a perspective view of a front end or rear end of the industrial truck.

### DETAILED DESCRIPTION OF THE EMBODIMENTS

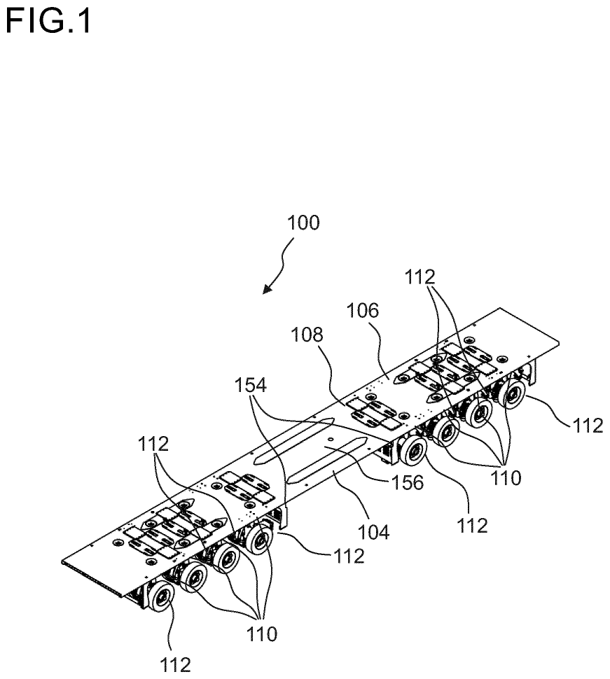

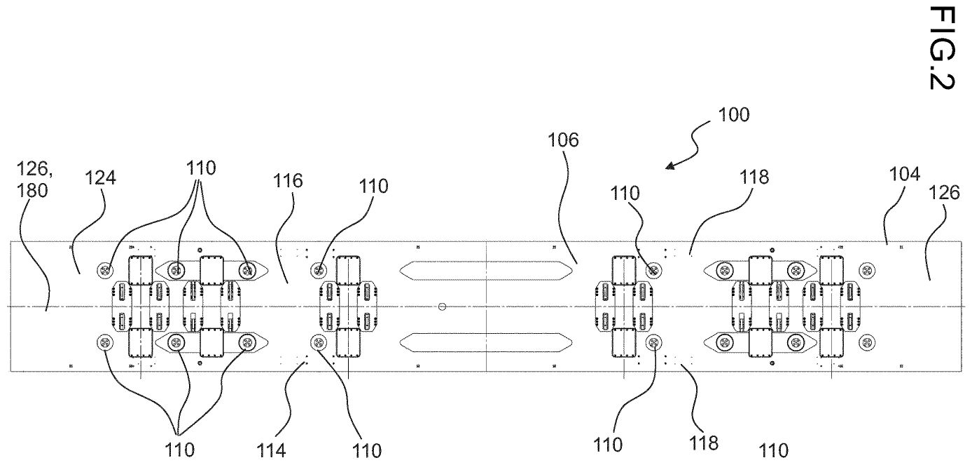

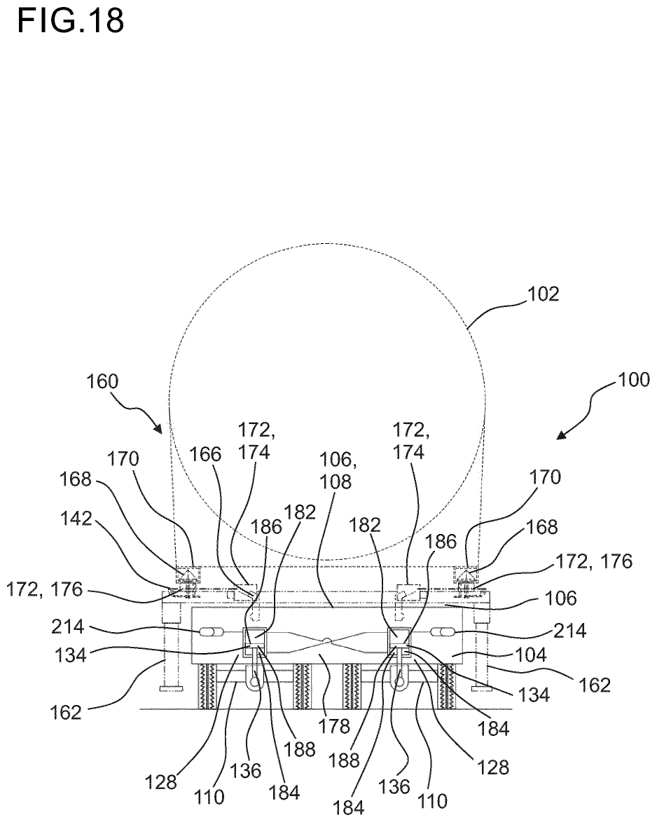

FIG. 1 shows a perspective view of an industrial truck 100 according to the present invention. FIG. 2 shows a plan view of the industrial truck 100. The industrial truck 100 is configured for transporting at least one container 102 (FIG. 18). For this purpose, the industrial truck 100 comprises a vehicle frame 104. The vehicle frame 104 comprises a loading platform 106 formed by an upper surface 108 of the vehicle frame 104. The vehicle frame 104 further comprises height-adjustable wheel suspensions 110. Particularly, the vehicle frame 104 comprises a plurality of height-adjustable wheel suspensions 110. Merely as an example, the vehicle frame 104 comprises 16 height-adjustable wheel suspensions 110 in total. The wheel suspensions 110 each comprise at least two adjacent wheels 112. The number of wheels 112 is determined such that a ground pressure of the industrial truck 100 in a loaded state is less than or equal to a predetermined threshold. The threshold is 833 KN/m². The wheel suspensions 110 are arranged as four independent quadrants 114, 116, 118, 120. The quadrants 114, 116, 118, 120 are arranged as pairs at a front portion 122 and a rear portion 124 of the vehicle frame 104 with respect to a longitudinal direction 126 of the industrial truck 100. Thus, each quadrant 114, 116, 118, 120 comprises four wheel suspensions 110, wherein at a left front portion 122, at a right front portion 122, at a left rear portion 124 and at a right rear portion 124 four wheel suspensions 110 are arranged. The height-adjustable wheel suspensions 110 are configured for lowering and raising the industrial truck 100 relative to a ground surface such as a road surface. The industrial truck 100 is able to drive on a normal road infrastructure. To this end, the load on the road surfaces must not exceed the values according to SLW 60 of DIN 1072-2025. To achieve this, the industrial truck 100 is equipped with a sufficient number of wheels 112 and axles of the wheel suspensions 110. This distributes the weight evenly on the road surface and the industrial truck 100 can drive on normal roads despite its very high weight. For example, the industrial truck 100 with a loading length of 52 feet has 32 tires and 16 half axles. This is a design difference from the two-axle AGVs with 4 tires used in ports, which can only run on infrastructure specially prepared for heavy loads and therefore cannot be retrofitted in terminals.

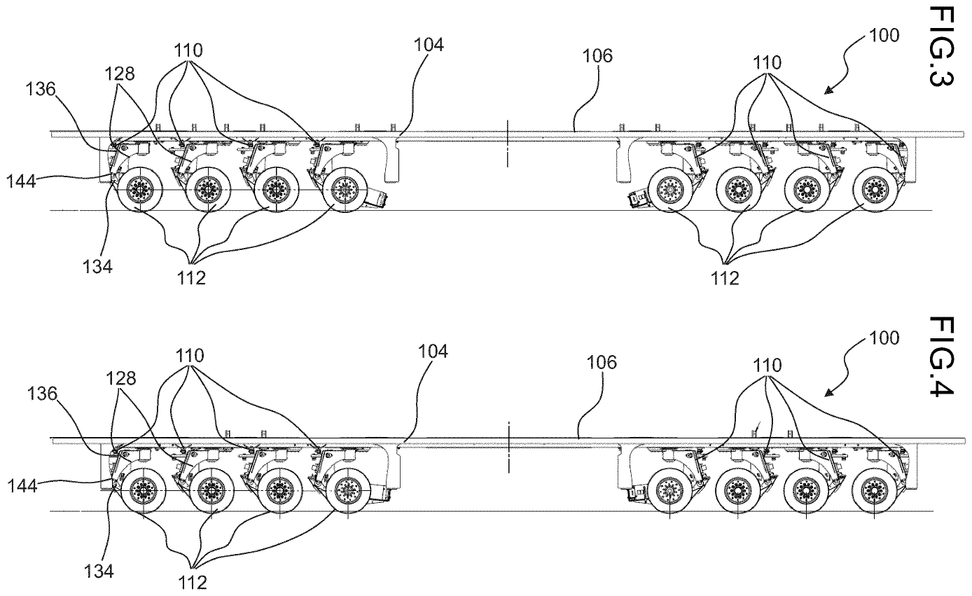

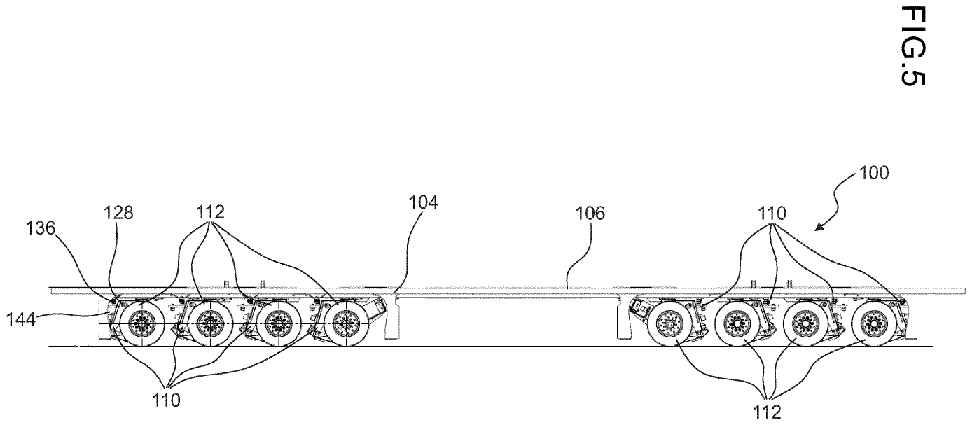

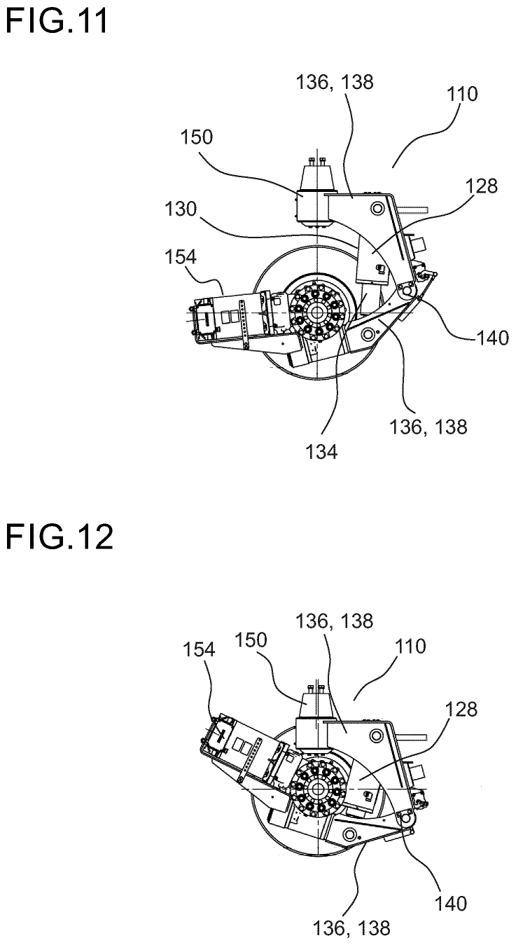

FIG. 3 shows a lateral view of the industrial truck 100 in a raised position. FIG. 4 shows a lateral view of the industrial truck 100 in an intermediate position. FIG. 5 shows a lateral view of the industrial truck 100 in a lowered position. For raising and lowering the industrial truck 100, the wheel suspensions 110 each comprise at least one hydraulic cylinder 128. Each of the hydraulic cylinders 128 is filled with a hydraulic fluid. Each of the hydraulic cylinders 128 comprise a cylinder barrel or cylinder casing 130, a piston 132 (FIG. 18), a piston rod 134 and a hinge 136. The piston 132 is connected to the piston rod 134 or integrally formed therewith. The piston 132 and the piston rod 134 are moveably arranged with respect to the cylinder casing 130. The cylinder casing 130 and the piston rod 134 are connected to one another by means of the hinge 136. By supplying hydraulic fluid to or discharging hydraulic fluid from the cylinder casing 130, the position of the piston 132 within the cylinder casing 130 varies. Thereby, the piston 132 retracts into the cylinder housing or moves out of the cylinder casing 130. Particularly, as commonly known, the hinge 136 consists of two hinge portions 138 (FIGS. 11 to 17) connected to one another pivotally around a hinge axis 140. Thus, the two hinge portions 138 approach one another or depart from one another. Thereby, the distance between the hinge portions 138 decreases or increases which in turn raises or lowers the industrial truck 100.

With respect to the illustrations of FIGS. 3 to 5, the industrial truck 100 is configured for lifting the vehicle frame 104 in the raised position such that the vehicle frame 104 is removed from its supporting surface such as a road, floor or soil. In the raised position, the industrial truck 100 may lift a support frame 142 (FIG. 18). In the lowered position, the industrial truck 100 is configured to move towards a position under or below the support frame 142 or pass therethrough.

In the intermediate position, the industrial truck 100 may move together with or without the support frame 142 under normal plane road conditions. It is explicitly stated that the industrial truck 100 is configured to move in each of the lowered, raised or intermediate positions.

The industrial truck 100 further comprise a height sensor 144 configured for determining a height of the industrial truck 100. The height sensor 144 is configured for determining the height of the industrial truck 100 by detecting a position of the hinge 136. Particularly, the height sensor 144 is configured to detect whether the hinge portions 138 are in an expanded, retracted position or any position therebetween. Thereby, the position of the hydraulic cylinders 128 may be determined.

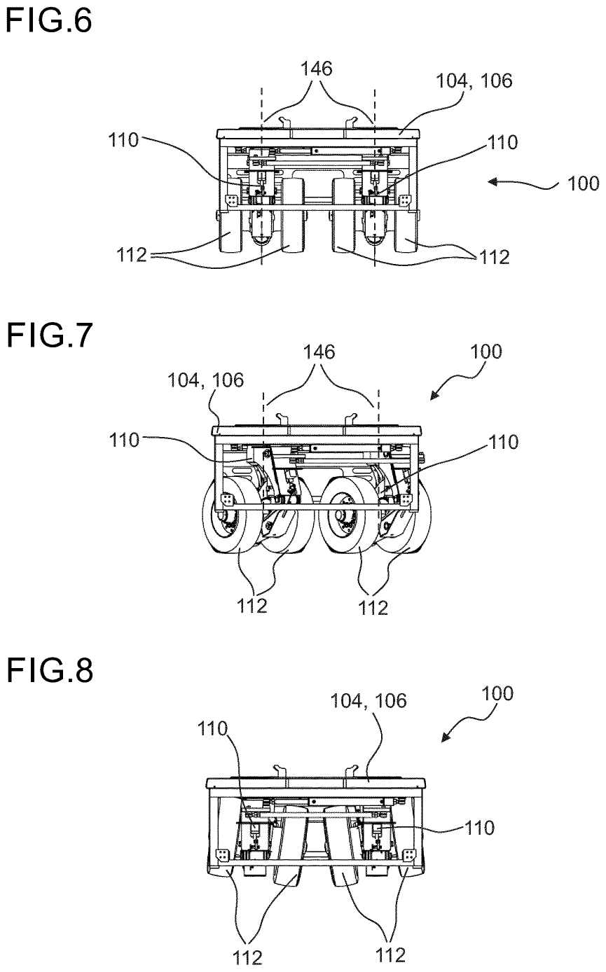

FIG. 6 shows a front view of the industrial truck 100. The wheel suspensions 110 are rotatable around an axis 146 extending perpendicular to the loading platform 106 of the vehicle frame 104.

FIG. 7 shows a front view of the industrial truck 100 in with wheels 112 in a turned position. As the wheel suspensions 110 are rotatable around the axis 146 extending perpendicular to the loading platform 106 of the vehicle frame 104, the wheels 112 may be turned as shown in FIG. 7. Thus, the industrial truck 100 may be steered.

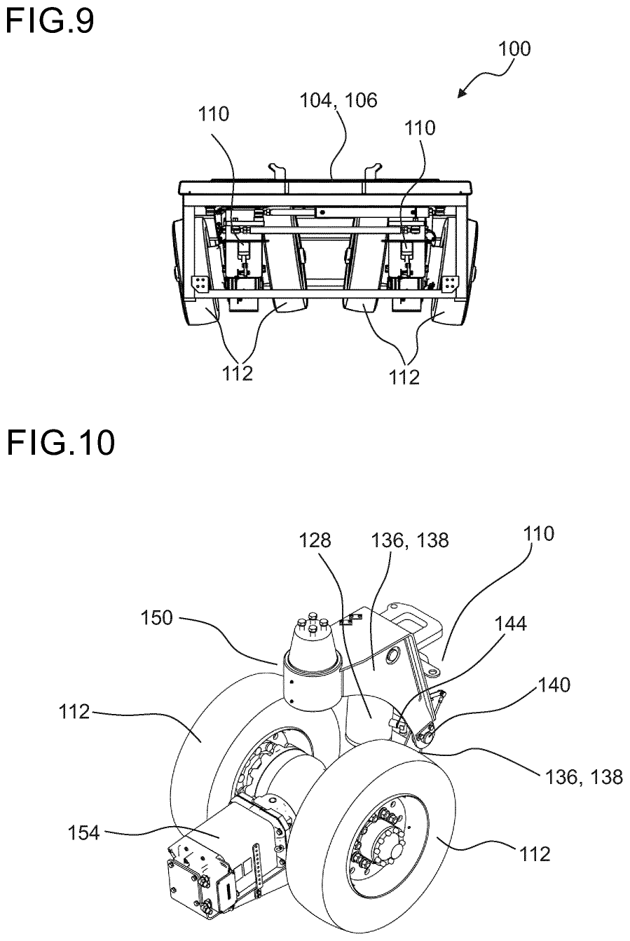

FIG. 8 shows a front view of the industrial truck 100 with wheels 112 in a pivoted position. FIG. 9 shows a front view of the industrial truck 100 with wheels 112 in another pivoted position. As can be taken from FIGS. 8 and 9, the wheel suspensions 110 allow the wheels 112 to pivot or tilt relative to the loading platform 106 of the vehicle frame 104. Thereby, the wheels 112 may be lifted or lowered relative to the loading platform 106 depending on the surface on which the industrial truck 100 moves.

As is further shown in FIGS. 3 to 5, the industrial truck 100 further comprises at least one power source 148 configured for supplying power to the wheels 112. The power source 148 may be a motor such as an electric motor. Particularly, the power source 148 is arranged at at least some of the wheel suspensions 110 so as to supply the wheels 112 of these wheel suspensions 110 with driving power. The wheel suspensions 110 comprise bogies 150, 152. At least some of the bogies 150, 152 are driven bogies 150 at which the power source 148 is located. With other words, the power source 148 is configured to drive the wheels 112 of these driven bogies 150.

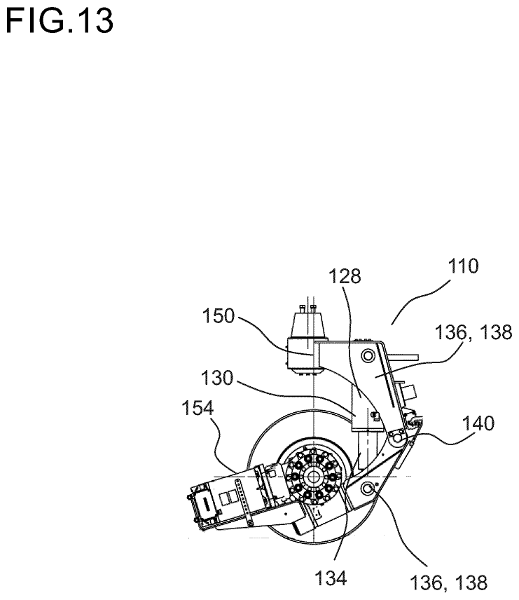

FIG. 10 shows a perspective view of a driven bogie 150. FIG. 11 shows a lateral view of the driven bogie 150 in an intermediate position. FIG. 12 shows a lateral view of the driven bogie 150 in a lowered position. FIG. 13 shows a lateral view of the driven bogie 150 in a raised position. As shown in FIGS. 10 to 13, the power source 148 is located between the wheels 112 of the driven bogies 150. As the power sources 148 are located at the driven bogies 150between the wheels 112, the driving power may be supplied directly to the wheels 112 without any intermediate gears or transmissions or only with a few gears or transmissions therebetween. It is explicitly stated that in each of the positions, i.e. the raised position, the lowered position or any intermediate position, the wheels 112 of the driven bogie 150 may be driven so as to move the industrial truck 100.

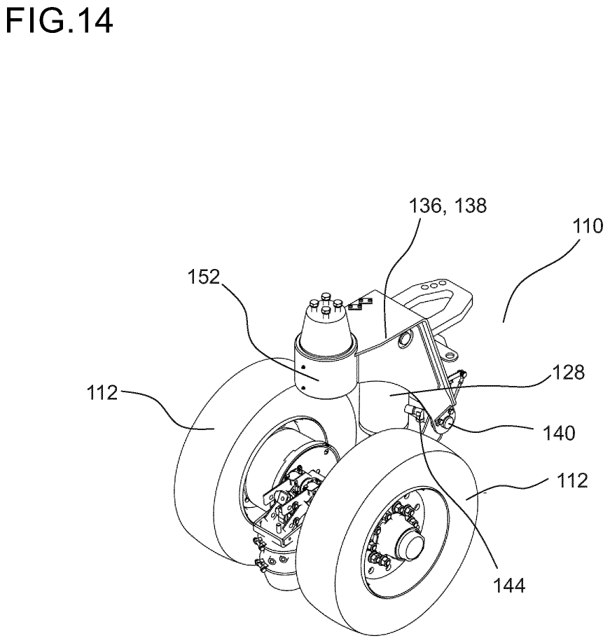

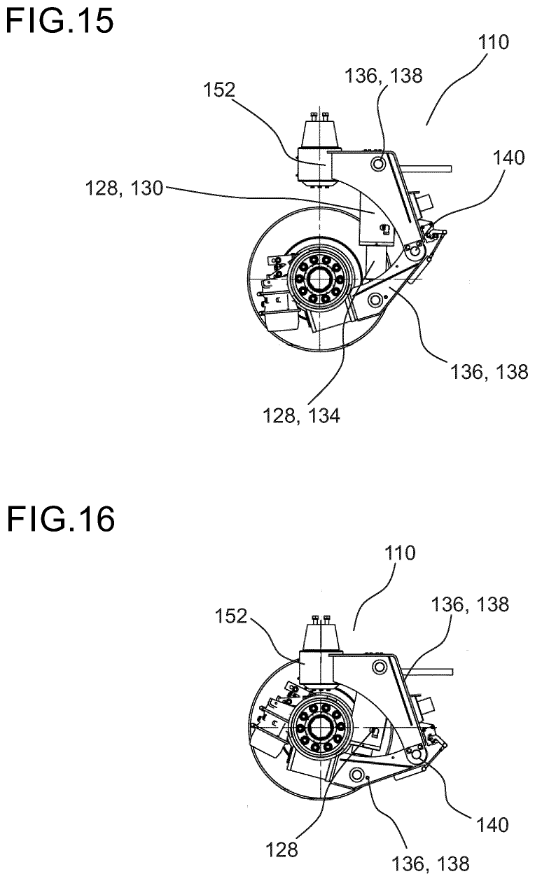

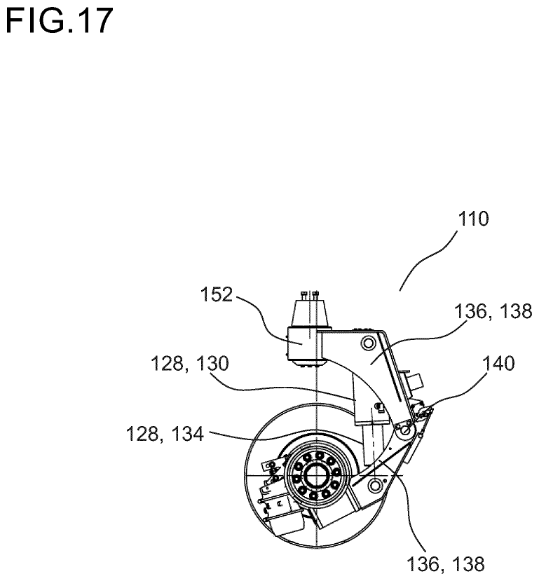

Further, the wheel suspensions 110 may comprise some undriven bogies 152. The wheels 112 of these bogies 152 are not driven but are passive or idle wheels 112 which move when the driven wheels 112 are supplied with power from the power source 148. FIG. 14 shows a perspective view of an undriven bogie 152. FIG. 15 shows a lateral view of the undriven bogie 152 in an intermediate position. FIG. 16 shows a lateral view of the undriven bogie 152 in a lowered position. FIG. 17 shows a lateral view of the undriven bogie 152 in a raised position. The undriven bogies 152 substantially are identical to the driven bogies 150, wherein only the power source 148 is omitted. It is explicitly stated that in each of the positions, i.e. the raised position, the lowered position or any intermediate position, the wheels 112 of the undriven bogie 152 may be indirectly driven by driving the wheels 112 of the driven bogies 150 so as to move the industrial truck 100.

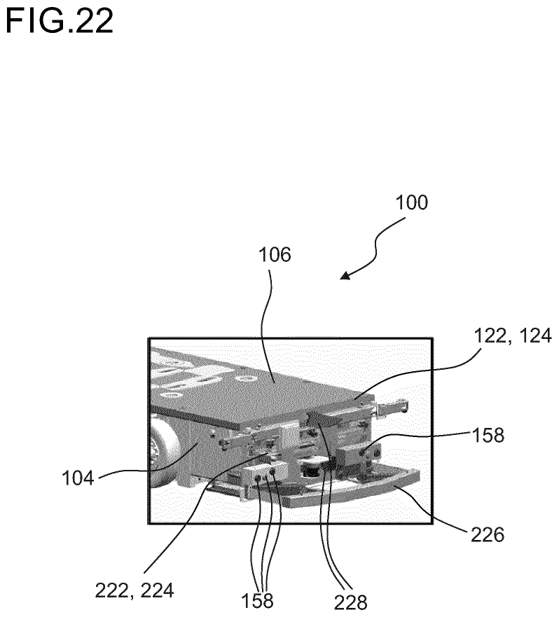

As is shown among others in FIG. 1, the industrial truck 100 further comprises a control unit 154. The power source 148 and the control unit 154 are arranged below the loading platform 106. Particularly, the control unit 154 is located below a center portion 156 of the vehicle frame 104. The control unit 154 is configured for controlling an operation of the industrial truck 100 such as the driving direction, the driving speed, and/or the height of the industrial truck 100. The industrial truck 100 further comprises lights 158 (FIG. 22) arranged at the front portion 122 and the rear portion 124 of the vehicle frame 104. The control unit 154 is configured to switch the lights 158 at the front portion 122 and the rear portion 124 of the vehicle frame 104 to a state of forward or rearward moving. With other words, the control unit 154 is configured to switch the colour of the lights 158 so as to indicate the front portion 122 and the rear portion 124 which may vary as the industrial truck 100 may move in two opposite directions. Further, the driving direction and other information may be indicated by the lights 158. Thus, under control of the control unit 154, the lights 158 comprise one or more functions of a dipped headlight, rear light, brake light, daytime running light, and direction indicator.

FIG. 18 shows a schematical cross-sectional view of the industrial truck 100. The industrial truck 100 is configured for transporting the at least one container 102 on a self-supporting support frame 142. The industrial truck 100 and the support frame 142 may be part of a system 160 comprising the industrial truck 100 and the support frame 142. The support frame 142 includes four legs 162, the lateral distance of which is greater than the width of the industrial truck 100, and the height of which is dimensioned such that the industrial truck 100 can be moved under the support frame 142 in the lowered state, and that the legs 162 are at a distance from the road surface in the raised state of the industrial truck 100. FIG. 18 shows the raised state of the industrial truck 100.

The vehicle frame 104 further comprises engagement elements 164 for fixing the support frame 142 onto the loading platform 106. The support frame 142 further comprises locking means 166. The locking means 166 are mounted on the support frame 142 so as to be movable between an open position and a closed position and projecting upwardly from the top side of the support frame 142 so that in their open position they can be inserted into openings 168 on the underside 170 of the container 102. The locking means 166 can be any suitable means known in the art that can interact with the openings 168 in the container 102. In the example shown the locking means 166 are twist locks. The support frame 142 further comprises a locking mechanism 172 for actuating the locking means 166. Merely as an example, the locking mechanism 172 comprises sliding elements 174 that are slidably mounted inside the support frame 142 and deflection linkages 176. The deflection linkages 176 are designed such that a displacement of the sliding elements 174 causes a movement of the locking means 166 from the open position to the closed position. Openings 168 are provided in the underside 170 of the support frame 142 through which the engagement elements 164 of the industrial truck 100 can act on the sliding elements 174. The sliding elements 174 are laterally displaceably mounted in the interior of the support frame 142, the displacement path of the sliding elements 174 being limited in each case by a stop (not shown in detail) firmly connected to the support frame 142, and the sliding elements 174 resting against the respective stop in the closed position of the locking means 166.

The industrial truck 100 further comprises a stabilizing mechanism 178 connecting at least some wheel suspensions 110 of laterally adjacent quadrants 114, 116, 118, 120 on opposite sides of a longitudinal axis 180 of the industrial truck 100. The stabilizing mechanism 178 is configured for at least partially hydraulically coupling at least one wheel suspension 110 of at least one of the quadrants 114, 116, 118, 120 with at least one corresponding wheel suspension 110 of a quadrant 114, 116, 118, 120 on an opposite side of the longitudinal axis 180 in an inverse fashion. Particularly, the stabilizing mechanism 178 is configured such that, when a load acts on the at least one wheel suspension 110 of the quadrant114, 116, 118, 120, the hydraulic coupling softens a damping of the corresponding at least one wheel suspension 110 of the quadrant 114, 116, 118, 120 on an opposite side of the longitudinal axis 180. For this purpose, wherein the hydraulic cylinders 128 are filled with a hydraulic fluid. The stabilizing mechanism 178 comprises a fluid communication of the hydraulic fluid of a predetermined number of the hydraulic cylinders 128 of the wheel suspensions 110 of a quadrant 114, 116, 118, 120 with a predetermined number of the hydraulic cylinders 128 of a laterally adjacent quadrant 114, 116, 118, 120 on the opposite side of the longitudinal axis 180. The predetermined number is less than a total number of hydraulic cylinders 128 number of the hydraulic cylinders 128 of the wheel suspensions 110 of laterally adjacent quadrants 114, 116, 118, 120. Particularly, the predetermined number of the hydraulic cylinders 128 is at least one. The fluid communication comprises a connection of a hydraulic volume defined by a top side 182 of the piston 132 of the at least one hydraulic cylinder 128 of the at least one wheel suspension 110 of the quadrant 114, 116, 118, 120 to a hydraulic volume defined by a lower side 184 of the piston 132 of the at least one hydraulic cylinder 128 of the at least one wheel suspension 110 of the quadrant on the opposite side of the longitudinal axis 180, and vice versa. The top side 182 may also be called suction side and the lower side 184 may also be called rod side. The hydraulic cylinders 128 are designed such that a top surface 186 of the piston 132 at the top side 182 and a lower surface 188 of the piston 132 at the lower side 184 have a predetermined ratio. For example, a ratio of the top surface 186 of the piston 132 at the top side 182 and the lower surface 188 of the piston 132 at the lower side 184 is 2:1.

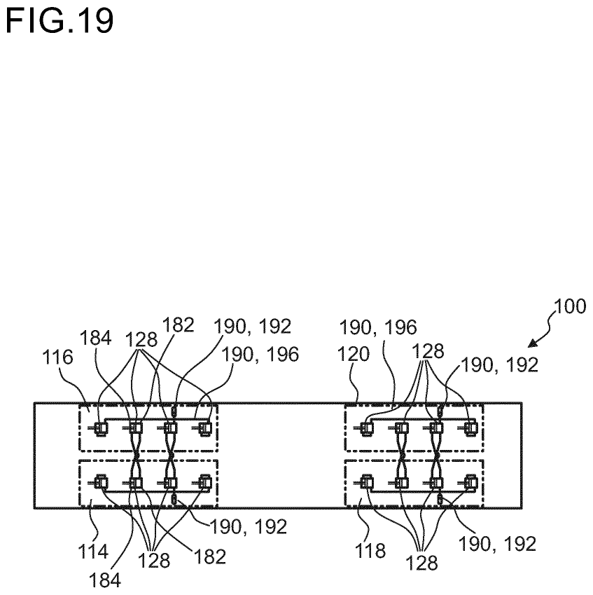

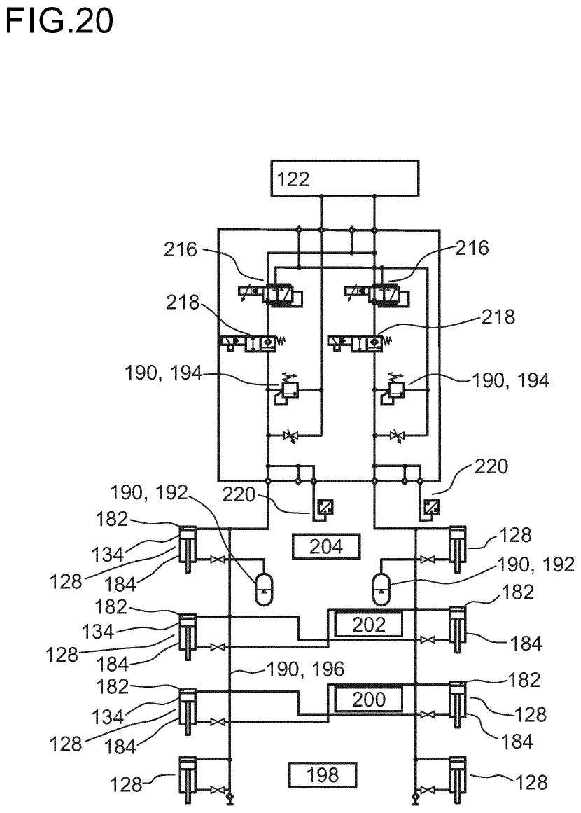

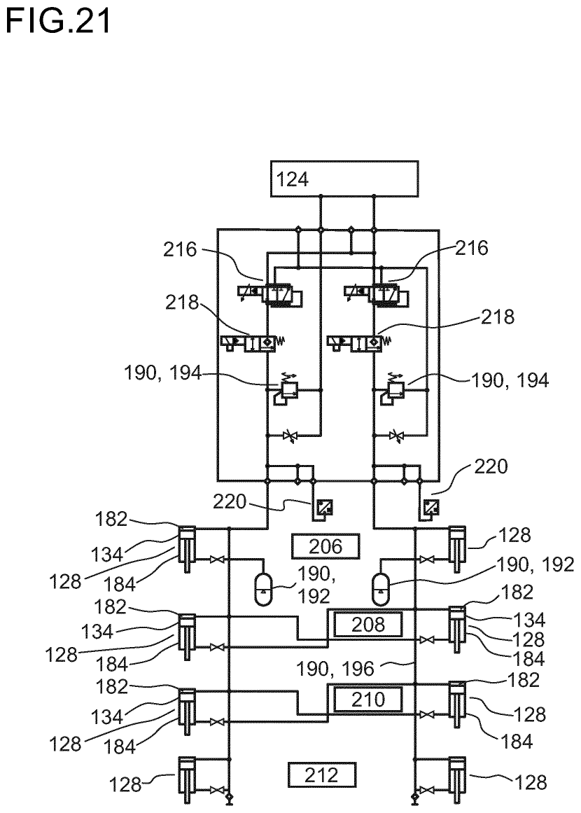

FIG. 19 shows a schematical plan view of a hydraulic system 190 of industrial truck 100. FIG. 20 shows a schematical illustration of the hydraulic system 190 at the front portion 122 of industrial truck 100. FIG. 21 shows a schematical illustration of the hydraulic system 190 at the rear portion 124 of industrial truck 100. The hydraulic system 190 comprises at least one hydraulic fluid reservoir 192 storing the hydraulic fluid, a hydraulic fluid pump 194 and a hydraulic fluid line 196. The hydraulic fluid reservoir 192 is in fluid communication with the hydraulic cylinders 128 of each quadrant 114, 116, 118, 120 by means of the hydraulic fluid line 196. The hydraulic cylinders 128 of each of the quadrants 114, 116, 118, 120 are in fluid communication with one another. Particularly, FIGS. 19 to 21 show the hydraulic cylinders 128 of the front portion 122 and the rear portion 124 arranged at first to eighth axes 198, 200, 202, 204, 206, 208, 210, 212. The fluid communication comprises a connection of a hydraulic volume defined by the top side 182 of the piston 132 of the hydraulic cylinders 128 of the wheel suspensions 110 of the left quadrants 114, 118 at the second, third, sixth and seventh axes 200, 202, 208, 210 to a hydraulic volume defined by the lower side 184 of the piston 132 of the hydraulic cylinders 128 of the wheel suspensions 110 of the right quadrants 116, 120 at the second, third, sixth and seventh axes 200, 202, 208, 210, and vice versa. Further, the fluid communication comprises a connection of a hydraulic volume defined by the top side 182 of the piston 132 to a hydraulic volume defined by the lower side 184 of the piston 132 of the same hydraulic cylinders 128 of the wheel suspensions 110 of the left quadrants 114, 118 and the right quadrants 116, 120 at the first, fourth, fifth and eighth axes 198, 204, 206, 212. The hydraulic pump 190 is configured for independently supplying hydraulic fluid to and/or discharging hydraulic fluid from the hydraulic cylinders 128 of each quadrant 114, 116, 118, 120 so as to adjust the amount of hydraulic fluid for each quadrant 114, 116, 118, 120. The hydraulic system 190 is configured to close the hydraulic fluid line 196 for laterally quadrants 114, 116, 118, 120 at least during a drive of the industrial truck 100. The height of the industrial truck 100 is adjustable by means of adjusting the amount of hydraulic fluid. The hydraulic fluid comprises a hydraulic liquid. The hydraulic fluid further comprises a gas such as nitrogen. The gas is stored in pressure tanks 214 and causes a damping effect to the wheel suspensions 110 when the industrial truck 100 moves and receives any shocks such as when moving across uneven ground.

As is particularly, shown in FIGS. 20 and 21, each of the front portion 122 and the rear portion 124 comprises for each of its quadrants 114, 116, 118, 120 a first actuating mechanism 216 for adjusting the hydraulic fluid amount for raising the industrial truck 100 and a second actuating mechanism 218 for adjusting the hydraulic fluid amount for lowering the industrial truck 100. The industrial truck 100 further comprises at least one load sensor 220 associated with each quadrant 114, 116, 118, 120. The load sensor 216 is configured for detecting a load acting on the respective quadrant 114, 116, 118, 120.

Depending on the implementation of the control unit 154, the industrial truck 100 may be realized as an automated guided vehicle (AGV). The vehicle has an unladen gross weight of between 10 and 30 t and can carry up to 150 tons of payload. In the 52-foot load length version, it has a total weight of 110 t, an unladen weight including the support frame 142 of 30 t and can carry a payload of 80 t.

Having a payload length of 26 feet, the industrial truck 100 may transport one container 102 having a length of 26 feet. Having a payload length of 52 feet, the industrial truck 100 may transport one container 102 having a length of 52 feet or two container 102s having each a length of 26 feet. Having a payload length of 80 feet, the industrial truck 100 may transport one container 102 having a length of 80 feet, two containers 102 having each a length of 20 to 40 feet, three container 102 each having a length up to 22 feet or four containers 102 each having a length up to 20 feet. Having a payload length of 96 feet, the industrial truck 100 may transport one container 102 having a length of 96 feet, two containers 102 having each a length of 45 feet, three container 102 each having a length up to 30 feet or four containers 102 each having a length up to 24 feet. The industrial truck 100 may carry more than one support frame 142 such as two support frames 142.

The support frame 142 may have a length of 20 feet, 40 feet or 60 feet. A support frame 142 having a length of 20 feet may be used to transport containers 102 having a length of 20 to 30 feet. A support frame 142 having a length of 40 feet may be used to transport containers 102 having a length of 30 to 60 feet. A support frame 142 having a length of 60 feet may be used to transport containers 102 having a length of 60 to 96 feet.

FIG. 22 shows a perspective view of a front end or rear end of the industrial truck 100. At front and rear ends 222, 224, the industrial truck 100 may comprise bumpers 226. A force acting on one of the bumpers 226 represents a collision with an object and causes an emergency stop of the industrial truck 100.

Hereinafter, the operation of the industrial truck 100 will be described in further detail.

As mentioned above, the industrial truck 100 has the height-adjustable wheel suspensions 110 which allow the industrial truck 100 to be lowered and raised relative to the road surface. As is further mentioned above, the support frame 142 comprises four legs 162, the lateral distance of which is greater than the width of the industrial truck 100, and the height of which is dimensioned such that the industrial truck 100 can be moved under the support frame 142 in the lowered state. In order to pick up the support frame 142, the control unit 154 operates the hydraulic system 190 and more particularly adjusts the amount of hydraulic fluid within the hydraulic cylinders 128 so as to lower the industrial truck 100. Particularly, the amount of hydraulic fluid within the top side 182 of the cylinder casing 130 of the hydraulic cylinders 128 is decreased such as by supplying the hydraulic fluid into the hydraulic fluid reservoir 192, the piston 132 retracts into the cylinder casing 130 and the industrial truck 100 is lowered. In the lowered position, the industrial truck 100 moves under the support frame 142. Depending on the driving direction, the control unit 154 switches the lights 158 at the front and rear portions 122, 124 so as to indicate the front and rear portions 122, 124 of the industrial truck 100. When driving under the support frame 142, the industrial truck 100 detects the type of the support frame 142, such as 20 feet, 40 feet or 60 feet. The industrial truck 100 has a payload length of either 26 feet, 52 feet, 80 feet or 96 feet.

When the industrial truck 100 is at a target position below the support frame 142, the control unit 154 operates the hydraulic system 190 and more particularly adjusts the amount of hydraulic fluid within the hydraulic cylinders 128 so as to raise the industrial truck 100. The predetermined height of the wheel suspensions 110 is adjusted by supplying a predetermined amount of a hydraulic fluid to the wheel suspensions 110. Particularly, the amount of hydraulic fluid within the top side 182 of the cylinder casing 130 of the hydraulic cylinders 128 is increased such as by supplying the hydraulic fluid from the hydraulic fluid reservoir 192, the piston 132 expands and moves out of the cylinder casing 130 and the industrial truck 100 is raised. After lifting and securing, the weight of the load is measured by the industrial truck 100. The weights of the different types of support frames 142 and empty load units are known master data, so that the payload weight of the transported product can be obtained from this and the filling level can also be obtained from the density and volume of the container 102. This information can be used to identify hazards during transport and, for example, to adjust the speed of liquids so that no dangerous surging movements occur.

In the raised state of the industrial truck 100, the legs 162 of the support frame 142 are at a distance from the road surface. Further, the movable engagement means engage in the openings 168 provided for this purpose in the support frame 142 in order to fix the support frame 142 on the industrial truck 100. Furthermore, the locking device of the support frame 142 is actuated by the engagement of the engagement means and can fix a container 102 located on the support frame 142 in the locked state. Needless to say, the industrial truck 100 may pick up a support frame 142 without a container 102 disposed thereon. The industrial truck 100 may then move to a destination.

The load can be picked up and set down independently. For this purpose, the industrial truck 100 carries the support frame 142. When setting down, the industrial truck 100 lowers the height until the frame is on the ground and then moves under the frame or drives under the frame when picking up and raises it. The industrial truck 100 can independently unlock and lock the support frame 142 and container 102 so that the container 102 and support frame 142 are secured on the industrial truck 100 during travel.

As shown in FIG. 22, the industrial truck 100 may comprise one or more sensors 228 for detecting potential objects such as obstacles, buildings, pedestrians, other vehicles and the like in the surroundings of the industrial truck 100. For example, for both driving directions, the industrial truck 100 may comprise two scanners or sensors 228 for detecting any objects in a near and far distance. When detecting an object, the industrial truck 100 may decelerate or even stop. Further, at the sides there may also be such sensors. Needless to say, the lateral sensors are arranged at positions which are not obstructed by the support frame 142 when transporting the same. The sensors for detecting any objects may be sensors configured for detecting the objects in a contactless manner such as LIDAR, Radar, IR or ultrasonic sensors or the like. Basically, the object detecting sensors may be implemented according to the requirements of IEC TS 62998-1 and having an integrity level of SIL 2.

The industrial truck 100 receives the transport orders from the logistics control system 160. The industrial truck 100 is technically capable of moving fully automatically along the selected route between the point of departure and the destination. The selected industrial truck 100 takes over the order in its industrial truck 100 computer and determines its position by measuring the wheel revolutions and compares these again and again by reading transponders in the roadway. Alternatively, the verification can be done by other common methods such as line detection, spatial recognition (3D cameras) or GPS (with reference signal). When transponders are used, they are fixed, measured and have a unique ID. The industrial truck 100 has a transponder antenna on the front and rear side, which reads the transponders in the lane with ID and position under the antenna. In this way, the navigation system in the industrial truck 100 detects the location and deviation from the planned route both in the front and in the rear and drives with centimeter accuracy. As a result, corrections are made precisely in the direction of travel, and the speed is determined and corrected if necessary. Even curves can be driven without dangerous surging in the tank being transported thanks to the very precise driving. The accuracy achieved here is an essential prerequisite for automatic driving in a hazardous area (with pipelines, for example, as is common on chemical sites).

Further, regarding the stabilization of the industrial truck 100, at least one wheel suspension of at least one of the quadrants 114, 116, 118, 120 is at least partially hydraulically coupled with at least one corresponding wheel suspension of a quadrant on an opposite side of the longitudinal axis 180 in an inverse fashion. Thereafter, the hydraulic coupling of the wheel suspensions 110 of the quadrants 114, 116, 118, 120 on opposite sides of the longitudinal axis 180 is closed. As mentioned above, the fluid communication comprises a connection of a hydraulic volume defined by the top side 182 of the piston 132 of the hydraulic cylinders 128 of the wheel suspensions 110 of the left quadrant at the second, third, sixth and seventh axes to a hydraulic volume defined by the lower side 184 of the piston 132 of the hydraulic cylinders 128 of the wheel suspensions 110 of the right quadrant at the second, third, sixth and seventh axes, and vice versa. Thus, if a load deviates from a center point, such as when the industrial truck 100 moves along a curve, the load pressure acting on the one side of the industrial truck 100 increases and this pressure acts as a negative pressure on the other side of the industrial truck 100. Thereby, a torsional moment or torque in the opposite direction is caused which counter-acts the load so as to cause a balancing effect. As the hydraulic coupling of the wheel suspensions 110 of the quadrants 114, 116, 118, 120 on opposite sides of the longitudinal axis 180 is closed during a drive, the pressure in one of the quadrants 114, 116, 118, 120 is always the same. Thus, the hydraulic cylinders 128 always carry the same load. The load is evenly distributed in a direction perpendicular to the longitudinal direction 126 and is at the center point above the first to eighth axes in the driving or longitudinal direction 126.

When the industrial truck 100 is at its destination, the industrial truck 100 stops and, the control unit 154 operates the hydraulic system 190 and more particularly adjusts the amount of hydraulic fluid within the hydraulic cylinders 128 so as to lower the industrial truck 100. The predetermined height of the wheel suspensions 110 is adjusted by supplying a predetermined amount of a hydraulic fluid to the wheel suspensions 110. Particularly, the amount of hydraulic fluid within the top side 182 of the cylinder casing 130 of the hydraulic cylinders 128 is decreased such as by supplying the hydraulic fluid to the hydraulic fluid reservoir 192, the piston 132 retracts and moves into the cylinder casing 130 and the industrial truck 100 is lowered. In the lowered state of the industrial truck 100, the legs 162 of the support frame 142 engage the road surface. Further, the movable engagement means disengage from the openings 168 provided for this purpose in the support frame 142 in order to release the support frame 142 from the industrial truck 100. Furthermore, the locking device of the support frame 142 is actuated by the engagement of the engagement means and can release a container 102 located on the support frame 142 in the unlocked state. The industrial truck 100 may then move to below the support frame 142 towards a new destination.

### CITED LITERATURE

DE 2 137 729 A
DE 20 2010 006 522 U1
EP 1 937 511 B1

List of reference numbers

| | |
|---|---|
| 100 | industrial truck |
| 102 | container |
| 104 | vehicle frame |
| 106 | loading platform |
| 108 | upper surface of vehicle frame |
| 110 | wheel suspension |
| 112 | wheel |
| 114 | quadrant |
| 116 | quadrant |
| 118 | quadrant |
| 120 | quadrant |
| 122 | front portion |
| 124 | rear portion |
| 126 | longitudinal direction |
| 128 | hydraulic cylinder |
| 130 | cylinder casing |
| 132 | piston |
| 134 | piston rod |
| 136 | hinge |
| 138 | hinge portion |
| 140 | hinge axis |
| 142 | support frame |
| 144 | height sensor |
| 146 | axis |
| 148 | power source |
| 150 | driven bogie |
| 152 | undriven bogie |
| 154 | control unit |
| 156 | center portion of vehicle frame |
| 158 | light |
| 160 | system |
| 162 | leg |
| 164 | engagement element |
| 166 | locking means |
| 168 | opening |
| 170 | underside |
| 172 | locking mechanism |
| 174 | sliding element |
| 176 | deflection linkage |
| 178 | stabilizing mechanism |
| 180 | longitudinal axis |
| 182 | top side of piston |
| 184 | lower side of piston |
| 186 | top surface |
| 188 | lower surface |
| 190 | hydraulic system |
| 192 | hydraulic fluid reservoir |
| 194 | hydraulic fluid pump |
| 196 | hydraulic fluid line |
| 198 | first axis |
| 200 | second axis |
| 202 | third axis |
| 204 | fourth axis |
| 206 | fifth axis |
| 208 | sixth axis |
| 210 | seventh axis |
| 212 | eigth axis |
| 214 | pressure tank |
| 216 | first actuating mechanism |
| 218 | second actuating mechanism |
| 220 | load sensor |
| 222 | front end |
| 224 | rear end |
| 226 | bumper |
| 228 | sensor |

1. An industrial truck for transporting at least one container, the industrial truck comprising
i. a vehicle frame comprising a loading platform formed by an upper surface of the vehicle frame, height-adjustable wheel suspensions, wherein the wheel suspensions each comprise at least two adjacent wheels, wherein the wheel suspensions are arranged as four independent quadrants, wherein the quadrants are arranged as pairs at a front portion and a rear portion of the vehicle frame with respect to a longitudinal direction of the industrial truck,
ii. a power source configured for supplying power to the wheels,
iii. a control unit configured for controlling an operation of the industrial truck, and
iv. a stabilizing mechanism connecting at least some one wheel suspensions of laterally adjacent quadrants on opposite sides of a longitudinal axis of the industrial truck, wherein the stabilizing mechanism is configured for at least partially hydraulically coupling at least one wheel suspension of at least one of the quadrants with at least one corresponding wheel suspension of a quadrant on an opposite side of the longitudinal axis in an inverse fashion.

2. The industrial truck according to claim 1, wherein the stabilizing mechanism is configured such that, when a load acts on the at least one wheel suspension of the quadrants, the hydraulic coupling softens a damping of the corresponding at least one wheel suspension of the quadrant on an opposite side of the longitudinal axis.

3. The industrial truck according to claim 1, wherein the wheel suspensions each comprise at least one hydraulic cylinder, wherein the hydraulic cylinders are filled with a hydraulic fluid, wherein the stabilizing mechanism comprises a fluid communication of the hydraulic fluid of a predetermined number of the hydraulic cylinders of the wheel suspensions of a quadrant with a predetermined number of the hydraulic cylinders of a laterally adjacent quadrant on the opposite side of the longitudinal axis.

4. The industrial truck according to claim 3, wherein each of the hydraulic cylinders comprises a piston, wherein the fluid communication comprises a connection of a hydraulic volume defined by a top side of the piston of the at least one hydraulic cylinder of the at least one wheel suspension of the quadrant to a hydraulic volume defined by a lower side of the piston of the at least one hydraulic cylinder of the at least one wheel suspension of the quadrant on the opposite side of the longitudinal axis, and vice versa.

5. The industrial truck according to claim 3, wherein the wheel suspensions are height-adjustable by means of the hydraulic cylinders, and/or wherein the amount of hydraulic fluid is separately adjustable for each quadrant.

6. The industrial truck according to claim 5, further comprising a hydraulic system comprising at least one hydraulic fluid reservoir storing the hydraulic fluid, a hydraulic fluid pump and a hydraulic fluid line, wherein the hydraulic fluid reservoir is in fluid communication with the hydraulic cylinders of each quadrant by means of the hydraulic fluid line, wherein the hydraulic pump is configured for independently supplying hydraulic fluid to and/or discharging hydraulic fluid from the hydraulic cylinders of each quadrant so as to adjust the amount of hydraulic fluid for each quadrant.

7. The industrial truck according to claim 6, wherein the hydraulic system is configured to close the hydraulic fluid line for laterally adjacent quadrants at least during a drive of the industrial truck.

8. The industrial truck according to claim 6, wherein a height of the industrial truck is adjustable by means of adjusting the amount of hydraulic fluid.

9. The industrial truck according to claim 4, further comprising a height sensor configured for determining a height of the industrial truck.

10. The industrial truck according to claim 9, wherein each of the hydraulic cylinders comprise a cylinder casing, a piston, a piston rod and a hinge, wherein the piston and the piston rod are moveably arranged with respect to the cylinder casing, wherein the cylinder casing and the piston rod are connected to one another by means of the hinge.

11. The industrial truck according to claim 1, further comprising at least one load sensor associated with each quadrant, wherein the load sensor is configured for detecting a load acting on the respective quadrant.

12. The industrial truck according to claim 1, wherein a number of wheels is determined such that a ground pressure of the industrial truck in a loaded state is less than or equal to a predetermined threshold.

13. The industrial truck according to claim 1, further comprising lights arranged at the front portion and the rear portion of the vehicle frame.

14. A system comprising the industrial truck according to claim 1 and at least one support frame for receiving at least one container, wherein the support frame comprises four legs, a lateral distance of which is greater than a width of the industrial truck, and a height of which is dimensioned such that the industrial truck can be moved under the support frame in a lowered state, and the legs are at a distance from a ground surface in a raised state of the industrial truck.

15. A method of stabilizing the industrial truck according to claim 1, the method comprising the following steps:
i. at least partially hydraulically coupling at least one wheel suspension of at least one of the quadrants with at least one corresponding wheel suspension of a quadrant on an opposite side of the longitudinal axis in an inverse fashion,
ii. adjusting a predetermined height of the wheel suspensions, and
iii. closing the hydraulic coupling of the wheel suspensions of the quadrants on opposite sides of the longitudinal axis.

16. The industrial truck according to claim 3, wherein the hydraulic fluid is a liquid or a gas.

17. The industrial truck according to claim 12, wherein the predetermined threshold is 833 kN/m².

18. The industrial truck according to claim 3, wherein the hydraulic cylinders of each of the quadrants are in fluid communication with one another.

19. The industrial truck according to claim 10, wherein the height sensor is configured for determining the height of the industrial truck by detecting a position of the hinge.

20. The industrial truck according to claim 13, wherein the control unit is configured to switch the lights at the front portion and the rear portion of the vehicle frame to a state of forward or rearward moving.
